(19) United States
(12) Patent Application Publication
(10) Pub. No.: US 2026/0071691 A1
(43) Pub. Date: Mar. 12, 2026

(54) Diaphragm valve

(71) Applicant: ASCO SAS, LUCE (FR)

(72) Inventors: Daniel SCHMIDT, CHATEAUNEUF EN THYMERAIS (FR); Olivier GLANDOR, FONTAINE LA GUYON (FR); Romain LEMERCIER, CHARTRES (FR)

(21) Appl. No.: 19/318,848

(22) Filed: Sep. 4, 2025

(30) Foreign Application Priority Data
Sep. 6, 2024 (FR) 2409484

(51) Int. Cl. F16K 27/02

(52) U.S. Cl. CPC F16K 27/0236

(57) ABSTRACT

A valve is provided having a valve body (2), a shut-off diaphragm (6), a cap (10) attached to the shut-off diaphragm, a plurality of fastening elements (16) fastened to the cap (10), each having a head (40), and at least one locking element (15). The at least one locking element is held captive on the valve body, able to move between an unlocked position in which it allows the passage of the head of the corresponding fastening elements and a locked position in which it engages beneath the head of the fastening elements to allow the fastening of the cap (10) on the valve body (2) by tightening of the one or more fastening elements (16).

### RELATED APPLICATION

This application claims the benefit of priority to French Patent Application No. French Patent Application No. 24 09484, filed on Sep. 6, 2024, the entirety of which is incorporated by reference.

### TECHNICAL FIELD The present invention relates to diaphragm valves.

### PRIOR ART

Diaphragm valves have a valve body supporting a diaphragm that acts as a shutter. The diaphragm is held by a cap fastened to the valve body. An actuator having a drive mechanism acts on the valve to deform it and make it adopt open or closed configurations.

The diaphragms used in this type of valve can experience intense wear, and this makes it necessary to change them regularly. This is particularly the case in aseptic valves in which the steam sterilization of the elements of the valve tends to degrade the diaphragm, making it a consumable that has to be replaced very frequently.

The cap and the valve body are generally assembled by a number of screws, studs or bolts that can be large depending on the type of valve, which will have to be unscrewed and then completely screwed back in. During the entire time for reassembly of the valve, the operator has to hold the actuator in position, along with the fastening elements to prevent them from falling. It is sometimes also necessary to follow a crosswise screwing scheme, to ensure satisfactory compression of the diaphragm. As a result, changing a diaphragm is both time-consuming and impractical.

US9638339B2, US2022128162A1 and US11236833B2 describe diaphragm valves in which the base of the cap has hooks that come to be attached via a rotational movement to elements extending beyond the body of the valve.

EP3333465B1, EP4067709A1 and WO2022128640A1 disclose diaphragm valves of which the cap is attached to the body of the valve by a system inspired by fastenings of bayonet type. Via a rotational movement, elements fastened to the body of the valve engage in the narrowest part of the fastenings and are thus blocked. US2015/0354718A1 discloses a valve in which the valve body bears fastening elements beneath the heads of which tabs of a locking ring can engage.

These various devices known from the prior art make it possible to easily detach the cap from the body of the valve in order to access the diaphragm. However, to ensure the external sealing of the valve, numerous additional pieces, such as systems for clamping the diaphragm by prestressing with the aid of rings and Belleville washers or other spring systems, are necessary, and this complicates the structure of the valve.

There is therefore a need to benefit from a diaphragm valve that makes it possible to replace the diaphragm quickly and easily, while at the same time maintaining a relatively simple structure to ensure both internal and external sealing of the valve.

### SUMMARY OF THE INVENTION

The invention aims to meet this need and relates, according to one of its aspects, to a valve having:
a valve body with openings passing through it,
a shut-off diaphragm,
a cap attached to the shut-off diaphragm,
a plurality of fastening elements fastened to the cap, each having a head extending beyond a corresponding opening of the valve body, and
at least one locking element for at least one of said fastening elements, held captive on the valve body, able to move between an unlocked (i.e. mounting) position in which it allows the passage of the head of the one or more corresponding fastening elements and a locked (i.e. blocking) position in which it engages beneath the head of the one or more fastening elements to allow the fastening of the cap on the valve body by tightening of the one or more fastening elements.

The invention has numerous advantages.

First of all, it makes the replacement of the diaphragm easier. The valve body can be removed quickly, as the latter is held in position as soon as the one or more locking elements are brought into the locked position. This makes it possible to free up the operator's hands until the next operation, which can be grasping a wrench for tightening the fastening elements. In the event of damage to the fastening elements, the cap and the fastening elements can be replaced without having to remove the valve body from the fluidic circuit to which it is connected, for example without having to unsolder the inlet and outlet connectors.

In addition, access to the fastening elements is not hindered by any part of the valve, as the heads of the fastening elements are situated on the side opposite the actuator. Thus, the fastening elements can be screwed or unscrewed easily with a standard tool such as a motorized screwdriver. Access to the diaphragm is also made easier.

Finally, the arrangement of the fastening elements on the inner side of the cap makes it possible to realize, if desired, the latter without roughnesses or indentations on its outer side (i.e. the upper side when the valve is oriented head up), and therefore to limit the risk of accumulation of dirt, and this makes the valve easier to clean and is of great interest in environments subject to strict hygiene standards, such as the food, pharmaceutical or cosmetic industries.

The valve may have a single one or more locking elements, depending on the variants, and this or these locking elements may be made movable relative to the valve body in a plurality of ways, by sliding or rotating.

The or each locking element is thus mounted, in implementation examples of the invention, so as to be able to slide on the valve body.

The or each locking element may be configured, in examples, to engage simultaneously beneath the heads of two or more fastening elements, in the locked position.

The valve has, for example, four fastening elements disposed in pairs on either side of a bulge of the valve body; each locking element may be mounted on one side of said bulge. The locking elements may be mounted symmetrically with respect to a longitudinal axis of the valve. The or each locking element advantageously has an opening allowing the passage of the head of one of the fastening elements in the unlocked position.

The or each locking element may also be mounted so as to rotate on the valve body.

The valve then has, for example, two locking elements mounted so as to rotate about a common axis of rotation. These locking elements may each have at one end a thinned portion with a hole passing through it, the thinned portions being offset in the thickness of the locking element so as to be superposed at the articulation while at the same time allowing the locking elements to pivot in one and the same plane.

The valve may have two pairs of locking elements disposed on either side of a bulge of the valve body.

In an implementation variant of the invention, the locking element is arranged to engage simultaneously beneath all the heads of the fastening elements.

The locking element may then have, when viewed from below, the overall shape of an H, with four branches and a central articulation, at least two diametrically opposite branches may have a notch, preferably in the form of an arc of a circle, arranged to allow the passage of the head of a corresponding fastening element via an axial movement, and all the branches may have a generally U-shaped opening defining a support for the head of a respective fastening element once the locking element has been brought into the locked position.

Preferably, regardless of the mounting, so as to slide or to rotate, of the one or more locking elements, the or each locking element has, preferably at at least one, and better still at each opening intended to receive a fastening element to be locked, a retaining relief opposing the unlocking of the locking element, i.e. a movement of the locking element towards the initial unlocked position freeing up the one or more fastening elements, for example a relief formed by the contour of a counterbore centred on the axis of the fastening element and of sufficient diameter to receive said head.

Preferably, the fastening elements are threaded.

Also preferably, the cap has internally tapped barrels, passing through corresponding holes in the diaphragm, and the fastening elements are screws, in particular of the ISO CHC standard, screwed into these barrels.

The barrels can have a smooth outer surface in contact with the diaphragm, and this limits the risk of damage thereto and can contribute to the precise positioning thereof on the cap. Preferably, these barrels are engaged in bores of corresponding diameter in the diaphragm, preferably with the presence of a mounting clearance when the diaphragm is new. The use of standard screws makes it easier to replace them in the event of damage, and makes it possible to limit the manufacturing cost.

The barrels may have a free end of frustoconical shape, and this makes the mounting of the diaphragm easier.

The barrels may be made in a single piece monolithically with the cap.

The valve has an actuator that may be of any type. This actuator acts on the diaphragm and is situated on the same side as the cap, on the opposite side from the valve body relative to the diaphragm.

The invention also relates to a method for changing a diaphragm of a valve according to the invention, comprising the steps consisting of:
unscrewing, preferably in less than ten turns, better still less than five, the fastening elements,
moving the one or more locking elements into the unlocked position,
separating the valve body from the cap,
replacing the diaphragm with a new one,
replacing the valve body on the cap, by making the fastening elements pass through the openings of the valve body,
bringing the one or more locking elements into the locked position,
tightening the fastening elements to fasten the diaphragm between the valve body and the cap.

The fastening elements are preferably unscrewed with as few turns as possible, sufficiently to decompress the diaphragm and to be able to release the aforementioned retaining relief.

### BRIEF DESCRIPTION OF THE DRAWINGS

The invention may be understood better from reading the following description of nonlimiting implementation examples thereof, and from examining the appended drawing, in which:

FIG. 1 is a perspective view of an exemplary valve according to the invention,

FIG. 2 is a view similar to FIG. 1, from another viewing angle,

FIG. 3 is a perspective view, from below, of the valve in the unlocked position,

FIG. 4 is a view similar to FIG. 3, in the locked position

FIG. 5 shows the valve before mounting of the valve body and the diaphragm,

FIG. 6 is a view similar to FIG. 5, from another viewing angle,

FIG. 7 is a perspective view, from below, of an embodiment variant of the valve,

FIG. 8 shows the locking elements of the valve in FIG. 7 in the unlocked position,

FIG. 9 is a view similar to FIG. 7 with the locking elements unlocked,

FIG. 10 is a perspective view, from below, of an embodiment variant of the valve, with the locking elements shown in the unlocked position,

FIG. 11 is a view from below with the locking elements in the unlocked position, and

FIG. 12 is a view similar to FIG. 11 with the locking elements in the locked position.

### DETAILED DESCRIPTION

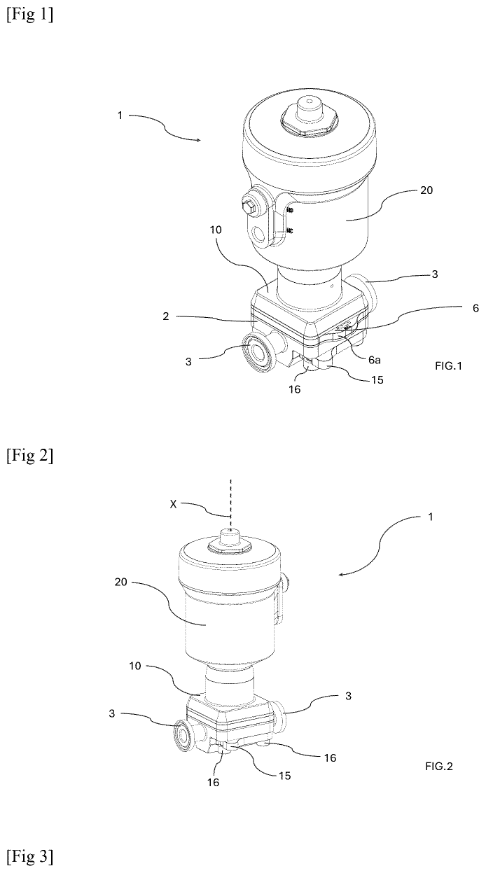

The valve 1 shown in FIGS. 1 to 6 has a valve body 2 that can have, as illustrated, two connectors 3 disposed on two opposite sides. The connectors 3 may be flanged or threaded or welded connectors. The fluid to be controlled by means of the valve 1 can enter through one of the connectors, pass through the body 2 when the valve 1 is open, and flow through the other connector. The valve body 2 may be made of metal, in particular stainless steel or other corrosion-resistant metal, or of plastic.

The valve body 2 is assembled to a cap 10 as one with an actuator 20, which is known per se and may be of any type: manual, electric, hydraulic or pneumatic, a combination thereof or another type.

The valve 1 has a diaphragm 6 interposed between the valve body 2 and the cap 10, and which is actuated by the actuator 20, in a manner known per se, between open and shut-off positions. The valve 1 may be an aseptic diaphragm valve, realized to avoid any zone of retention of the fluid that passes through it. The diaphragm 6 may be a composite diaphragm comprising a support layer, preferably made of rubber, for example ethylene-propylene-diene monomer (EPDM), optionally comprising a reinforcing fabric, and a sealing layer, preferably made of a plastic polymer, for example polytetrafluoroethylene (PTFE). The support layer and the sealing layer may form a single piece or two separate pieces brought into contact with one another. As a variant, the diaphragm only has a single layer, preferably made of rubber, for example EPDM. Whether or not it is composite, the diaphragm can have a thickness of between 0.8 and 12 mm.

The diaphragm 6 may have, as illustrated, a contour substantially similar at least in part, preferably completely similar, to that of the facing face of the valve body 2.

The diaphragm 6 may have a lateral protuberance 6a extending beyond the valve body 2 and the base of the cap 10 when the valve 1 is assembled. This protuberance may have traceability information or other information.

The diaphragm 6 may have, as illustrated, an insert 6c making it possible to connect by any appropriate means, in particular by bayonet fastening or other fastening, the diaphragm to the mechanism of the actuator 20. As a variant, the diaphragm does not have an insert.

The insert 6c can be injection moulded together with the rest of the diaphragm or attached to the diaphragm. The insert 6c may have any relief for coupling to the mechanism 20a of the actuator.

The diaphragm 6 may have a domed central part 6d, which is in particular substantially circular when viewed from above, connected to the insert 6c. The diaphragm 6 may have a flat peripheral part 6e, in particular of constant thickness, surrounding the domed central part 6d.

The cap 10 ensures the internal sealing of the valve 1 by coming to bear against the diaphragm.

The cap 10 may be made of metal, in particular stainless steel or any other corrosion-resistant metal, or of plastic.

The cap 10 has, on its inner face 10a turned towards the diaphragm 6, barrels 17 that are internally tapped to receive fastening elements 16 constituted in the example under consideration by screws with heads 40, preferably of the ISO CHC standard. The fastening elements 16 are preferably metallic, in particular made of stainless steel or another metal, which is in particular corrosion resistant.

The barrels 17 have a frustoconical portion 17a at the end.

In the example illustrated, the cap 10 has a contour of square shape with rounded corners when viewed from below, and the fastening elements 16 are four in number, being disposed in the corners of the square.

The diaphragm 6 has holes 6b of circular section for the passage of the barrels 17.

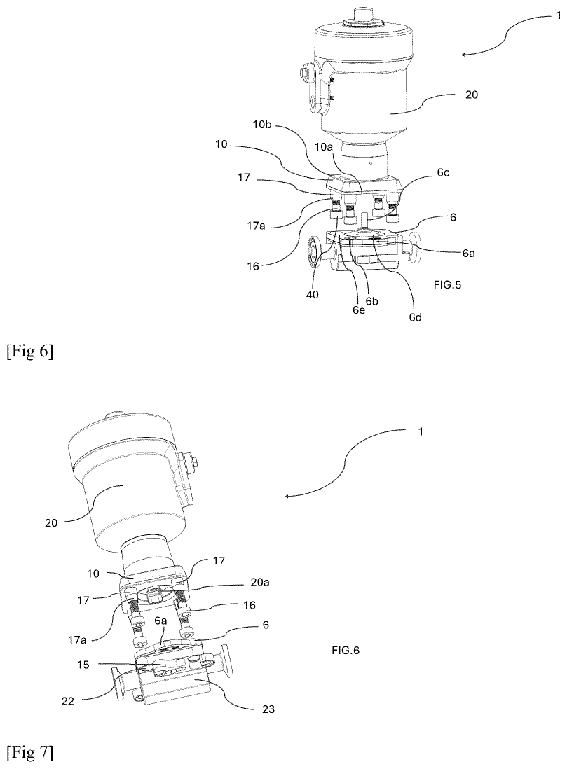

The valve body 2 is passed through, as can be seen in FIG. 6, by four openings 22 for the passage of the fastening elements 16, these openings 22 being for example, as illustrated, disposed in pairs on either side of a central bulge 23 of the valve body, forming a projection on the opposite side from the actuator 20.

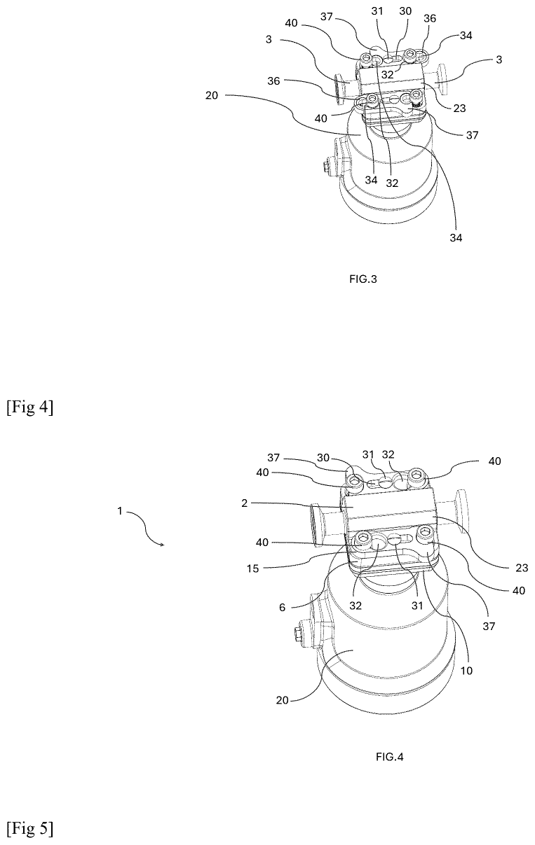

Two locking elements 15 are mounted captive on the valve body 2, each being able to move between an unlocked position shown in FIG. 3 and a locked position shown in FIG. 4.

Each locking element 15 has at its centre an oblong slot 30 in which is engaged a holding element such as a screw 31, which thus retains the locking element on the valve body 2 while at the same time allowing it to move between the locked and unlocked positions.

Each locking element 15 may be cut or stamped from a metal plate, in particular made of stainless steel. As a variant, each locking element is moulded from metal, in particular stainless steel or steel treated with a surface coating. Each element 15 may optionally be subjected to a surface hardening heat treatment.

Each locking element 15 has, as can be seen in particular in FIG. 3, an opening 32 for the passage of the head 40 of one of the fastening elements 16 when the locking element 15 is in the unlocked position.

Each locking element 15 also has two openings 34 that are narrower than the heads 40 of the fastening elements 16, which accommodate the threaded shanks of the latter when the locking element 15 is in the locked position.

One of the openings 34 opens onto the opening 32 while the other opening 34 opens at a longitudinal end of the locking element 15.

Counterbores 36 of which the diameter is slightly greater than that of the heads 40 are present on the external face of the locking element 15, being centred on the respective axes of the fastening elements 16 when the locking element 15 is in the locked position.

Each locking element 15 may have a tab 37 that projects laterally, which the operator may push or pull to make the locking element slide between its unlocked and locked positions during the assembly of the valve.

The arrangement of the two locking elements 15 may be symmetrical with respect to the longitudinal axis X of the valve, as illustrated.

The central bulge 23 may be delimited laterally by rectilinear flanks that may contribute to the guiding of each locking element 15 in its movement.

The valve body 2 can be mounted in the following manner.

The fastening elements 16 being partially screwed into the barrels 17, the diaphragm 6 is put in place on the cap 10 by being engaged on the barrels 17, which can contribute to the positioning thereof. As a variant, the diaphragm 6 is placed on the valve body 2.

Next, the cap 10 can be engaged on the valve body 2, with care being taken beforehand to position the locking elements 15 in the unlocked position.

The locking elements 15 can then be moved into the locked position, and this ensures that the cap 10 is held on the valve body 2 and frees up the operator's hands.

The fastening elements 16 can be tightened on the locking elements 15. The tightening of the fastening elements 16 on the locking elements ensures satisfactory compression of the peripheral zones of the diaphragm 6. The contour of the counterbores 36 constitutes a relief opposing the movement of the locking elements 15 towards the mounting position, in the event of slight loosening of a fastening element 16. During the use of the valve and in particular because of the sterilization steps, creep can be observed, resulting in a loss of tightness. In the event of loss of tightness, the presence of the counterbores 36 can contribute to securing the valve and prevent it from unlocking by promoting the quasi-embedding of the heads 40 of the fastening elements 16 in the locking elements.

The diaphragm 6 is replaced in a similar manner, by loosening the fastening elements 16, then moving the locking elements 15 to free up the heads 40 and allow the cap 10 to be separated from the valve body 2.

The variant in FIGS. 7 to 9 differs from the example that has just been described only by way of the shape of the locking elements 15 and the mounting thereof on the valve body 2.

In the example in these figures, the valve 1 has four rotary locking elements 15, mounted in pairs about common axes of rotation, on either side of the central bulge 23.

Each locking element 15 is in the form of a hook having an opening 34 arranged to engage on the threaded shank of a fastening element 16, but sufficiently narrow to block the head 40 thereof.

Counterbores 36 are realized on the external face of the locking elements 15, for the same purpose as detailed above.

The pivoting of the locking elements 15 of one and the same pair can be ensured by a pivot such as a screw 60, fastened in the valve body 2.

The locking elements 15 have thinned portions 61 and 62 that are offset in the direction of the thickness of the elements 15, which are superposed in the region of articulation about the screw 50, in order to allow the two elements 15 to pivot in one and the same plane, the external faces of the elements 15 thus being situated at the same level.

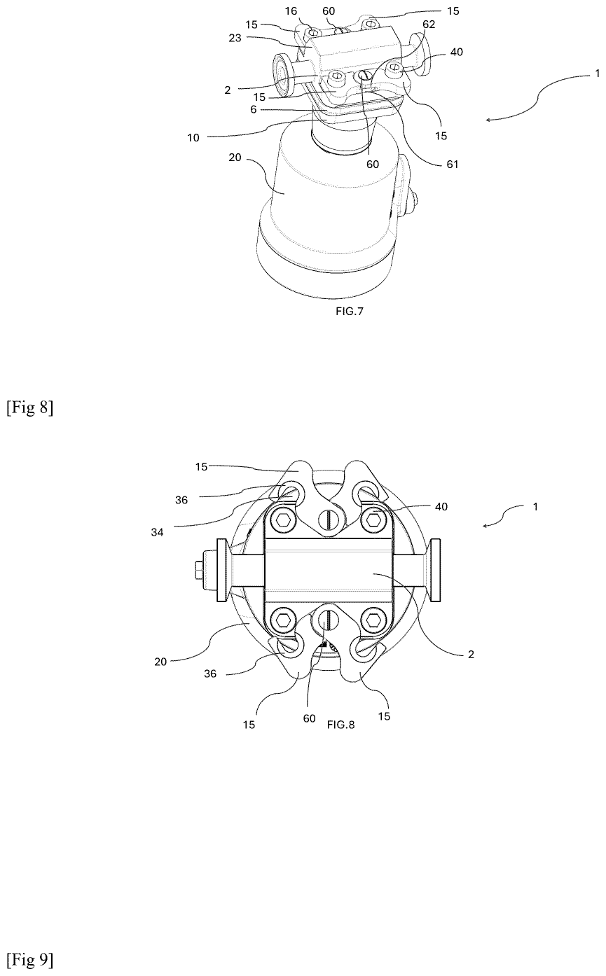

The angular displacement of the locking elements 15 is sufficient for, in the unlocked position, the elements 15 not to interfere with the passage of the heads 40 of the fastening elements 16, as illustrated in FIG. 8.

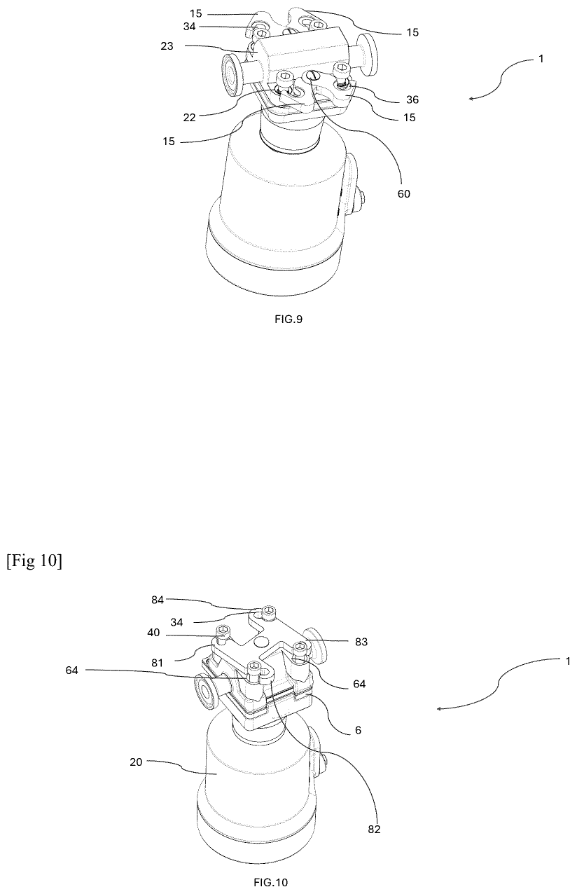

The embodiment variant in FIGS. 10 to 12 differs from the preceding ones in particular by the fact that the valve 1 has a single locking element 15 that is arranged to come simultaneously beneath all the heads 40 of the locking elements 16, in the locked position.

In this example, the locking element 15 has, when viewed from below, the overall shape of an H, with four branches 81 to 84, being articulated at its centre on the valve body 2 by means of an articulation element 88 such as a screw, to rotate about the longitudinal axis X of the valve 1.

The valve body 2 may have a face 2b facing the locking element 15, the shape of which is different from that illustrated in the figures that have just been described, because of the presence in the corners of zones 64 substantially at the same height as the centre thereof, and where the openings 22 serving for the passage of the heads 40 of the fastening elements 16 open.

The length of the fastening elements 16 is adapted accordingly, so as to allow the locking element 15 to engage beneath the heads 40, before tightening.

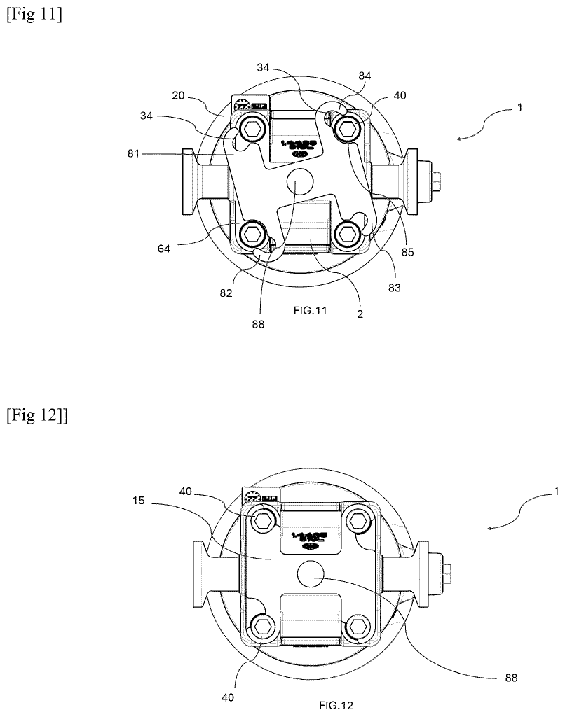

As can be seen in FIG. 11, the branches 81 to 84 of the locking element have openings 34 for accommodating the threaded shank of the fastening elements 16 when the locking element 15 is in the locked position.

The diametrically opposite branches 81 and 83 are symmetrical to one another with respect to the axis of articulation of the locking element 15.

The same applies to the branches 82 and 84. The latter, unlike the branches 81 and 83, each also have a notch 85 in the form of an arc of a circle for the passage of the heads 40 when the locking element 15 is in the unlocked position.

In all the exemplary embodiments, the external face 10b of the cap 10 situated on the side of the actuator 20 may be devoid of indentations or roughnesses, as illustrated, and this makes it easier to clean.

Of course, the invention is not limited to the examples illustrated.

In particular, it is possible to realize the locking elements in yet another way. The fastening elements may be disposed elsewhere than in the corners. The valve body may have a contour of another shape, in particular a circular shape.

There may also be a different number of fastening elements, for example three, five or six.

The valve body and the cap may have different shapes.

The holes in the diaphragm and the openings in the locking element may have other shapes.

The retention of the locking elements in the locked position in the event of slight loosening of the fastening elements may be achieved in some way other than by cooperation between the heads of the fastening elements and the locking elements, for example by means of a cooperation between the locking element and a corresponding relief of the valve body. The expression “having a” should be understood as being synonymous with “comprising at least one”, unless otherwise specified.

1. A valve comprising:
a valve body with openings passing through it,
a shut-off diaphragm,
a cap attached to the shut-off diaphragm,
a plurality of fastening elements fastened to the cap, each having a head extending beyond a corresponding opening of the valve body, and
at least one locking element for at least one of said fastening elements, held captive on the valve body, able to move between an unlocked position in which it allows the passage of the head of the one or more corresponding fastening elements and a locked position in which it engages beneath the head of the one or more fastening elements to allow the fastening of the cap on the valve body by tightening of the one or more fastening elements.

2. The valve according to claim 1, wherein the or each locking element is mounted so as to be able to slide on the valve body.

3. The valve according to claim 2, wherein the or each locking element is arranged to engage simultaneously beneath the heads of two fastening elements in the locked position.

4. The valve according to claim 3, further comprising four fastening elements disposed in pairs on either side of a bulge of the valve body, each locking element being mounted on one side of said bulge.

5. The valve according to claim 4, wherein the locking elements are mounted symmetrically with respect to a longitudinal axis of the valve.

6. The valve according to claim 2, wherein the or each locking element have an opening allowing the passage of the head of one of the fastening elements in the unlocked position.

7. The valve according to claim 1, wherein the locking element is mounted so as to rotate on the valve body.

8. The valve according to claim 7, further comprising two locking elements mounted so as to rotate about a common axis of rotation.

9. The valve according to claim 8, wherein the locking elements each have at one end a thinned portion with a hole passing through it, the thinned portions being offset in the thickness of the locking element so as to be superposed at the articulation while at the same time allowing the locking elements to pivot in one and the same plane.

10. The valve according to claim 8, further comprising two pairs of locking elements disposed on either side of a bulge of the valve body.

11. The valve according to claim 7, wherein the locking element is arranged to engage simultaneously beneath all the heads of the fastening elements.

12. The valve according to claim 11, wherein the locking element has, when viewed from below, the overall shape of an H, with four branches and a central articulation, at least two diametrically opposite branches having a notch arranged to allow the passage of the head of a corresponding fastening element via an axial movement, all the branches having a generally U-shaped opening defining a support for the head of a respective fastening element once the locking element has been brought into the locked position.

13. The valve according to claim 1, wherein the locking element has, at at least one opening intended to receive a fastening element to be locked, a retaining relief opposing a movement of the locking element towards the unlocked position, wherein said retaining relief is formed by the contour of a counterbore centred on the axis of the fastening element and of sufficient diameter to receive said head.

14. The valve according to claim 1, wherein the cap has internally tapped barrels, passing through corresponding holes in the diaphragm, and the fastening elements being screws of the ISO CHC standard, screwed into these barrels.

15. The valve according to claim 14, wherein the barrels have a free end of frustoconical shape.

16. The valve according to claim 14, wherein the barrels are made in a single piece monolithically with the cap.

17. A method for changing a diaphragm of a valve according to claim 1, comprising the steps of:
unscrewing in less than ten turns the fastening elements,
moving the one or more locking elements into the unlocked position,
separating the valve body from the cap,
replacing the diaphragm with a new one,
replacing the valve body on the cap, by making the fastening elements pass through the openings of the valve body,
bringing the one or more locking elements into the locked position, and
tightening the fastening elements to fasten the diaphragm between the valve body and the cap.
